(19) United States
(12) Patent Application Publication
(10) Pub. No.: US 2013/0187095 A1
(43) Pub. Date: Jul. 25, 2013

(54) THERMOSETTING ADHESIVE COMPOSITIONS

(71) Applicant: Designer Molecules, Inc., San Diego, CA (US)

(72) Inventors: Stephen M. Dershem, San Diego, CA (US); Gina Hoang, San Diego, CA (US); Melin Lu, San Diego, CA (US)

(73) Assignee: DESIGNER MOLECULES, INC., San Diego, CA (US)

(21) Appl. No.: 13/769,317

(22) Filed: Feb. 16, 2013

Related U.S. Application Data
(63) Continuation-in-part of application No. 11/639,625, filed on Dec. 14, 2006, now Pat. No. 8,378,017.
(60) Provisional application No. 60/754,400, filed on Dec. 29, 2005.

(51) Int. Cl. C09J 4/06

(52) U.S. Cl. CPC C09J 4/06
USPC 252/500; 525/289; 525/303; 525/530; 525/55; 524/532; 524/533; 524/612

(57) ABSTRACT

The invention is based on the discovery that adhesive compositions containing certain low-viscosity, mono-ethylenically unsaturated monomers have surprisingly good cure parameters, resulting in very little weight loss upon cure. Many of these monofunctional monomers used alone or in combination with other monofunctional monomers described herein have high glass transition temperatures when cured. Moreover, since these monomers are monofunctional the crosslink density of the adhesive composition does not increase (relative to multi-functional monomers), which in turns results in lower stress, lower modulus adhesive compositions. As such, these monomers are useful in a variety of thermoset adhesive compositions, such as for example, die attach adhesive compositions.

### RELATED APPLICATIONS

This application is a continuation-in-part of U.S. patent application Ser. No. 11/639,625, filed Dec. 14, 2006, issued Feb. 19, 2013 as U.S. Pat. No. 8,378,017, which in turn claims the benefit of priority of U.S. Provisional Application Ser. No. 60/754,400 filed Dec. 29, 2005, the entire disclosures of which are incorporated herein by reference.

### FIELD OF THE INVENTION

The present invention relates to thermosetting adhesive compositions, methods of preparation and uses therefor. In particular, the present invention relates to thermosetting compounds and compositions containing low molecular weight, mono-functional monomers.

### BACKGROUND OF THE INVENTION

Adhesives used in the electronic packaging industry typically contain a thermosetting resin combined with a filler and some type of curing initiator. These resins are primarily used in the electronics industry for the preparation of non-hermetic electronic packages. Adhesives useful for electronic packaging applications typically exhibit properties such as good mechanical strength, curing properties that do not affect the function of the component or the carrier, and rheological properties compatible with application to microelectronic and semiconductor components. Examples of such packages are ball grid array (BGA) assemblies, super ball grid arrays, IC memory cards, chip carriers, hybrid circuits, chip-on-board, multi-chip modules, pin grid arrays, and the like.

One area of continuing research in the electronic packaging industry is the development of low stress, high T_{g} adhesives. It is well known that glass transition (T_{g}) temperatures can be readily increased through the use of polyfunctional monomers. One, often very undesirable, consequence of the use of such polyfunctional monomers is that both cure stress and modulus are also significantly increased. Thus, the use of high levels of polyfunctional monomers to boost the T_{g} of thermoset adhesives can often be counter-productive in terms of the final cured properties of the adhesive. It would be very useful to have high T_{g} monofunctional monomers. These compounds could be used to lower crosslink density while preserving or, in many cases, increasing the glass transition temperature of the adhesive formulation. Therefore, it is desirable to have a thermoset with a high T_{g} and a low crosslink density. A higher T_{g} will retain the lower coefficient of thermal expansion (CTE) of α₁ (i.e. the low CTE that exists prior to the T_{g}). A thermoset adhesive with a high T_{g} and a low cross-link density is considered superior because this combination results in lower interfacial stress.

### SUMMARY OF THE INVENTION

The invention is based on the discovery that adhesive compositions containing certain low-viscosity, mono-ethylenically unsaturated monomers have surprisingly good cure parameters, resulting in very little weight loss upon cure. Many of these monofunctional monomers used alone or in combination with other mono-functional monomers described herein have high glass transition temperatures when cured. Moreover, since these monomers are mono-functional the cross-link density of the adhesive composition does not increase (relative to multi-functional monomers), which in turns results in lower stress, lower modulus adhesive compositions. As such, these monomers are useful in a variety of thermoset adhesive compositions, such as for example, die attach adhesive compositions.

Monofunctional, ethylenically unsaturated monomers are useful in adhesive formulations based on free radical cure because they can participate in chain extension polymerization without increasing the crosslink density of a thermoset composition. A current limitation in the art is the lack of suitable monofunctional monomers that have both high glass transition and low weight loss. Some higher molecular weight monofunctional monomers are available, such as octadecyl methacrylate, which has lower weight loss by virtue of its relatively high molecular weight. Unfortunately, such monomers also depress the glass transition temperature.

Isobornyl(meth)acrylate, styrene, and t-butylstyrene are commercially available, monofunctional monomers that give higher glass transition temperatures, but they also have very high weight loss. This makes them unattractive for use in many thermoset adhesive applications. The significant weight loss during cure that occurs when these monomers are used can result in voiding and, furthermore, their use is both an environmental and human health concern.

The ideal monofunctional monomers would have low weight loss during cure, low viscosity at room temperature, and a high T_{g} when cured. Described herein are a variety of ethylenically unsaturated monomers that independently, and/or in combination, possess all of these properties and overcome the limitations of the mono-functional monomers that are currently available commercially.

In one embodiment, there are provided adhesive compositions including at least one thermosetting resin and at least one monomer having the structure

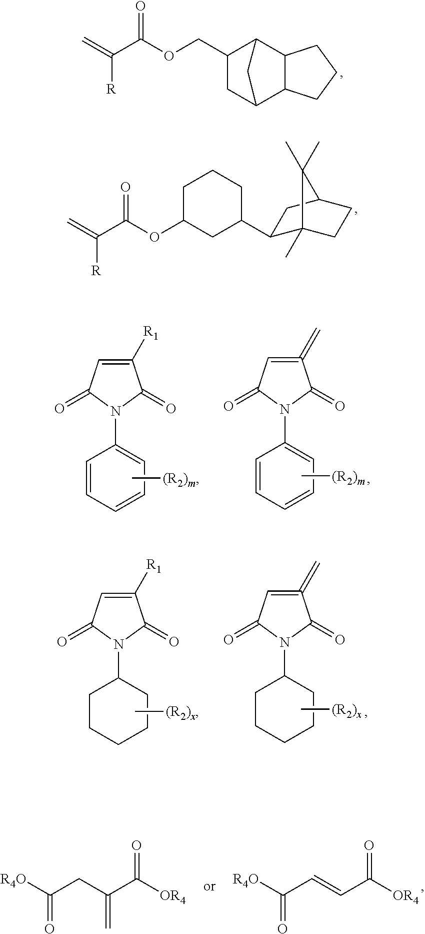

wherein each of R and R₁ is independently H or methyl, each R₂ is independently an alkyl, an alkoxy, an aryloxy, a halogen or —O(CO)—R₃, wherein R₃ is a C₁-C₁₀ alkyl, and each R₄ is independently H, alkyl, alkoxy, aryloxy, halide, —O(CO)—R_{3′} or any of:

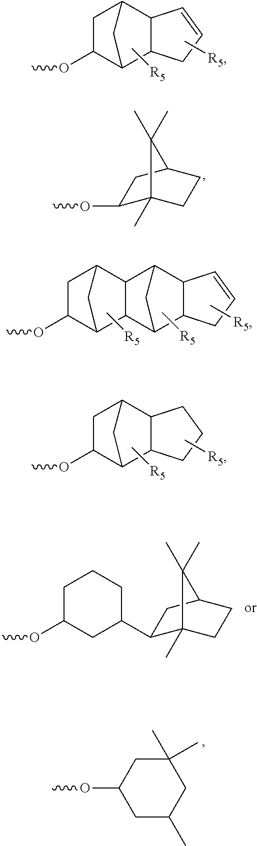

wherein in R₄:

R_{3′} is a C₁-C₁₀ alkyl or any of:

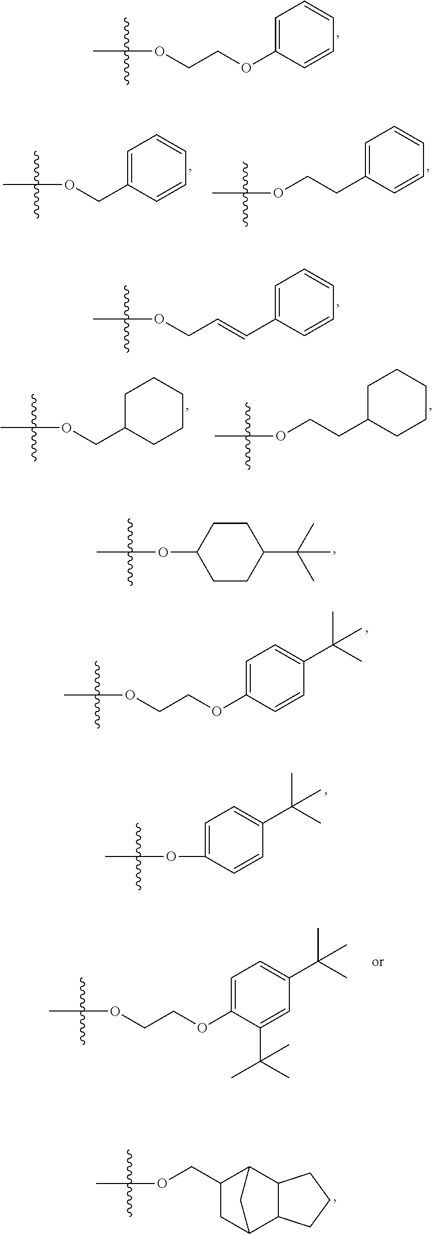

and

further in R₄, each R₅ is H or methyl.

In other embodiments of the invention, there are provided methods for increasing the T_{g} value of an adhesive composition without significantly increasing the modulus of the composition, methods for producing an adhesive composition having a T_{g} value greater than about 50° C., and methods for attaching a semiconductor die to a substrate.

### DETAILED DESCRIPTION OF THE INVENTION

It is to be understood that both the foregoing general description and the following Detailed Description are exemplary and explanatory only and are not restrictive of the invention claimed. As used herein, the use of the singular includes the plural unless specifically stated otherwise. As used herein, “or” means “and/or” unless stated otherwise. Furthermore, use of the term “including” as well as other forms, such as “includes,” and “included,” is not limiting. The section headings used herein are for organizational purposes only and are not to be construed as limiting the subject matter described.

Unless specific definitions are provided, the nomenclatures utilized in connection with, and the laboratory procedures and techniques of analytical chemistry, synthetic organic and inorganic chemistry described herein are those known in the art. Standard chemical symbols are used interchangeably with the full names represented by such symbols. Thus, for example, the terms “hydrogen” and “H” are understood to have identical meaning. Standard techniques may be used for chemical syntheses, chemical analyses, and formulation.

As used herein, “alkyl” refers to straight or branched chain hydrocarbyl groups having from 1 up to about 100 carbon atoms. Whenever it appears herein, a numerical range, such as “1 to 100” or “C₁-C₁₀₀”, refers to each integer in the given range; e.g., “C₁-C₁₀₀ alkyl” means that an alkyl group may comprise only 1 carbon atom, 2 carbon atoms, 3 carbon atoms, etc., up to and including 100 carbon atoms, although the term “alkyl” also includes instances where no numerical range of carbon atoms is designated). “Substituted alkyl” refers to alkyl moieties bearing substituents including alkyl, alkenyl, alkynyl, hydroxy, oxo, alkoxy, mercapto, cycloalkyl, substituted cycloalkyl, heterocyclic, substituted heterocyclic, aryl, substituted aryl, heteroaryl, substituted heteroaryl, aryloxy, substituted aryloxy, halogen, haloalkyl, cyano, nitro, nitrone, amino, amido, —C(O)H, —C(O)—, —S—, —S(O)₂—, —OC(O)—O—, —NR—C(O)—, —NR—C(O)—NR—, —OC(O)—NR—, wherein R is H or lower alkyl, acyl, oxyacyl, carboxyl, carbamate, sulfonyl, sulfonamide, sulfuryl and the like.

As used herein, “alkoxy” refers to a moiety having the structure O-alkyl, with alkyl defined as above.

As used herein,

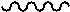

or “wavy bonds” refer to a generic attachment or termination point of the illustrated structure to other atoms, groups or molecules. Wavy bonds are used to denote terminal positions where the end group is not known, such as where the moiety depicted by a structural formula can be connected to other molecules such as a polymer chain. In other words, the end group can be any structurally compatible group or the moiety. The wavy bond designation is preferred over a straight bond notation in circumstances when the attachment or termination point is not specified, is not known, or can be any of a variety of groups. Straight bonds are used to indicate that the atom at the end of the bond is a carbon atom, whereas the wavy bond, on the other hand, signifies that the atom or group at the end of the bond can be any atom or group that is compatible with the illustrated structure to which the wavy bond is attached.

The present invention provides monofunctional, low molecular weight compounds that, when incorporated into an adhesive composition, increase T_{g} values of the adhesive compositions without significantly increasing the modulus of the compositions. As used herein, “monofunctional” refers to a compound that has one unit of ethylenic unsaturation. As used herein, “increase” or “significant increase” with respect to T_{g} values means that the T_{g} value of a given adhesive composition is at least 50° C. In other aspects, “increase” or “significant increase” means that the T_{g} value of a given adhesive composition is at least 100° C. In still other aspects, “increase” or “significant increase” means that the T_{g} value of a given adhesive composition is at least 150° C.

Mono-functional compounds contemplated for use in the practice of the invention include compounds having the structure

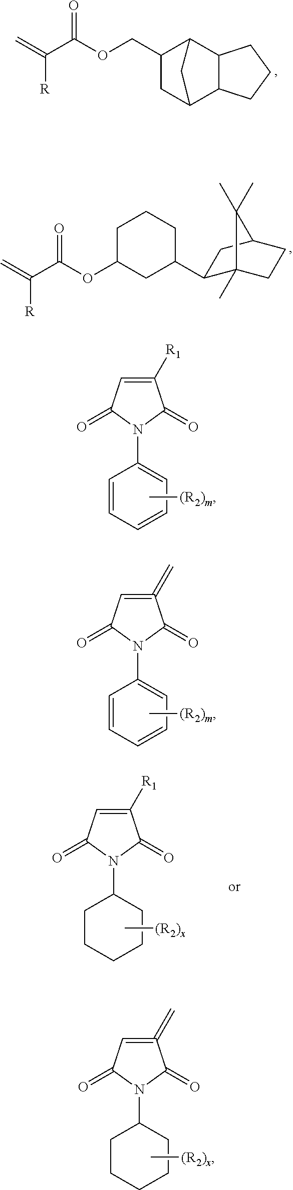

wherein each of R and R₁ is independently H or methyl, each R₂ is independently alkyl, alkoxy, aryloxy, halogen or —O(CO)—R₃, wherein R₃ is C₁-C₁₀ alkyl, m is 0 to 5 and x is 0 to 11.

In some embodiments of the invention, R₂ is methyl, ethyl, propyl, isopropyl, butyl, isobutyl, tert-butyl, phenyl, cyclohexyl, and the like. In other embodiments, R₂ is methoxy, ethoxy, propyloxy, phenoxy, and the like. In still other embodiments R₂ is a halide such as fluoride, chloride, or bromide. In other embodiments, R₂ is —O(CO)—R₃, wherein R₃ is C₁-C₅ alkyl.

Additional mono-functional compounds that are also contemplated for use in the practice of the invention include compounds having the structures

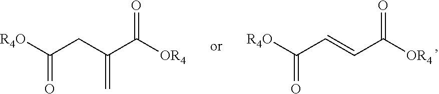

wherein each R₄ is independently H, alkyl, alkoxy, aryloxy, halide, —O(CO)—R₃ or any of:

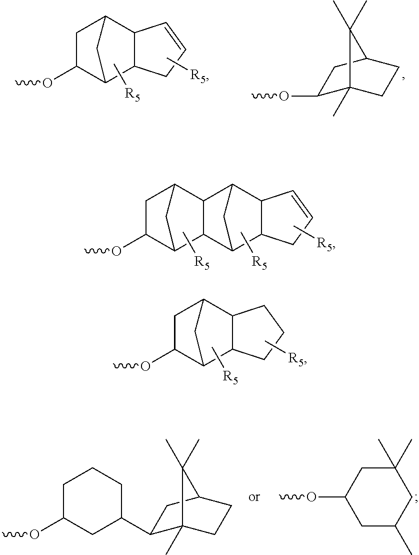

wherein in R₄:

R₃ is a C₁-C₁₀ alkyl or any of:

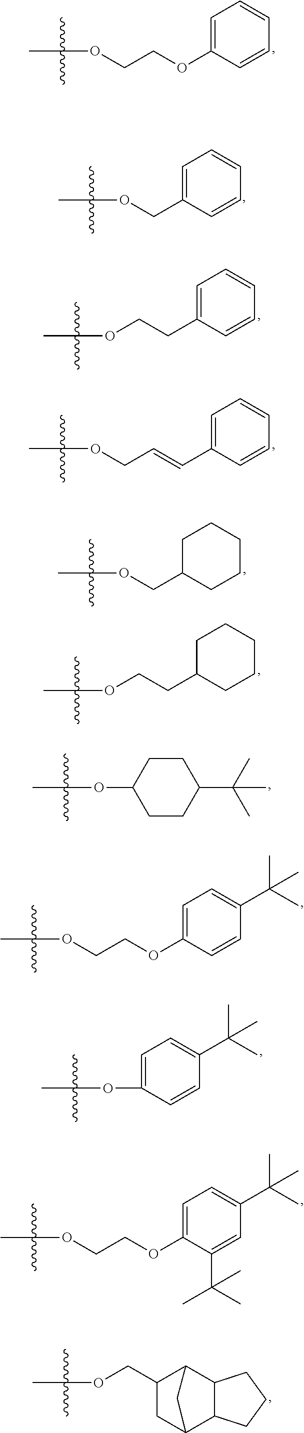

and

further in R₄, each R₅ is H or methyl.

Some representative examples of specific mono-functional compounds that are contemplated for use in the practice of the invention include, but are not limited to, tricyclodecanemethanol acrylate, tricyclodecanemethanol methacrylate, isobornylcyclohexyl acrylate or any of the following:

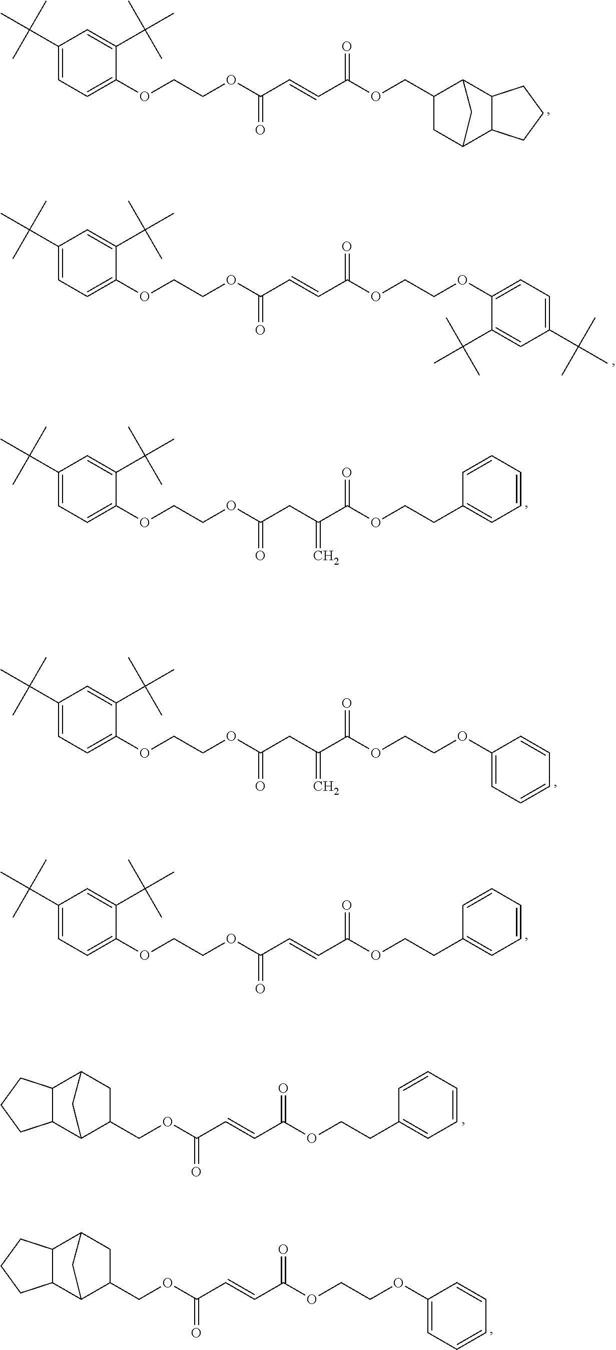

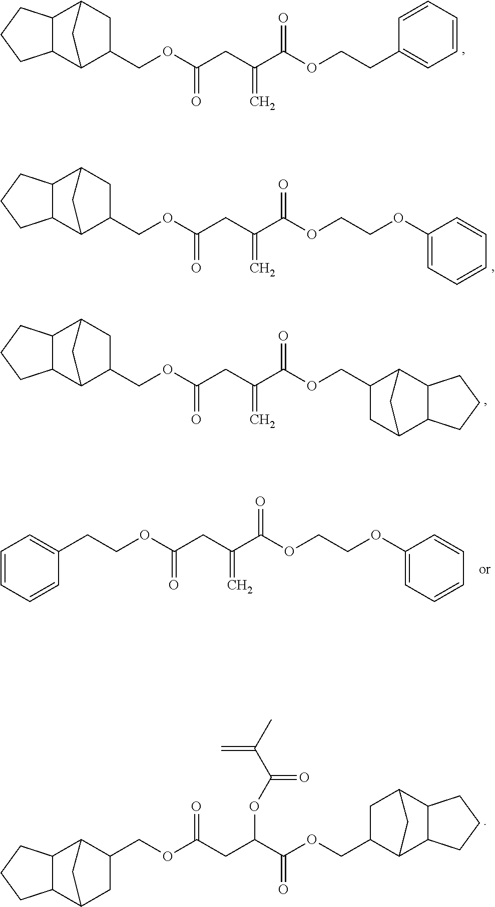 [SMILES: C=C(CC(=O)OCC1CC2CC1C1CCCC21)C(=O)OCCc1ccccc1 ; C=C(CC(=O)OCC1CC2CC1C1CCCC21)C(=O)OCCOc1ccccc1 ; C=C(CC(=O)OCC1CC2CC1C1CCCC21)C(=O)OCC1CC2CC1C1CCCC21 ; C=C(CC(=O)OCCc1ccccc1)C(=O)OCCOc1ccccc1 ; C=C(C)C(=O)OC(CC(=O)OCC1CC2CC1C1CCCC21)C(=O)OCC1CC2CC1C1CCCC21]

2-(2-methylacryloxy)-succinic acid bis-(octahydro-4,7-methanoinden-5-ylmethyl)ester, which is the last compound on the list provided immediately above, and similar compounds, could be made by condensing malic acid with alcohols. This can be utilized where the parent alcohols are primary, and are thus more reactive than the secondary alcohol residue that is already present in the malic acid starting material. These compounds could be made in a two step reaction. The first step includes reacting malic acid with 1.0 to 1.5 equivalents of one or more primary alcohols in the presence of an azeotroping solvent (e.g., heptane, octane, benzene, toluene, xylene, etc.). This first reaction may be done in the absence of any acid catalyst. The non-catalyzed condensation could be conducted at about 130° C. to 150° C. The second step includes converting the remaining secondary alcohol residue into a (meth)acrylate. This could be done using either an anhydride (e.g. methacrylic anhydride), an acid chloride (acryloyl or methacryloyl chloride), or direct condensation of acrylic acid and/or methacrylic acid in the presence of DCC (i.e., N,N′-dicyclohexylcarbodiimide).

In the practice of the invention, at least one mono-functional compound is combined with at least one thermosetting resin to produce a fully formulated adhesive composition. In some embodiments, two or more mono-functional monomers are combined to form a eutectic, which can then be readily combined with a thermosetting resin. Thermosetting resins contemplated for use in the practice of the invention include, for example, acrylates, methacrylates, maleimides, vinyl ethers, vinyl esters, styrenic compounds, allyl functional compounds, epoxies, oxetanes, oxazolines, benzoxazines, and the like.

The mono-functional compounds of the invention are typically present in invention adhesive compositions in an amount from 2 to 98 weight percent (wt %) based on the organic components present (excluding any fillers). In some embodiments, one monofunctional compound is combined with at least one thermosetting resin. In other embodiments, a combination of monofunctional compounds is added to more precisely control T_{g}, CTE, and modulus values.

In some embodiments, at least one curing initiator is typically present in the composition from 0.1 wt % to about 5 wt % based on total weight of the composition. In some embodiments, the initiator is a free-radical initiator. As used herein, the term “free radical initiator” refers to any chemical species which, upon exposure to sufficient energy (e.g., light, heat, or the like), decomposes into two parts which are uncharged, but which each possesses at least one unpaired electron. Preferred free radical initiators contemplated for use in the practice of the present invention are compounds which decompose (i.e., have a half life in the range of about 10 hours) at temperatures in the range of about 70° C. up to 180° C. Exemplary free radical initiators contemplated for use in the practice of the present invention include peroxides (e.g., dicumyl peroxide, dibenzoyl peroxide, 2-butanone peroxide, tert-butyl perbenzoate, di-tert-butyl peroxide, 2,5-bis(tert-butylperoxy)-2,5-dimethylhexane, bis(tert-butyl peroxyisopropyl)benzene, tert-butyl hydroperoxide), and the like.

The term “free radical initiator” also includes photoinitiators. For example, for invention adhesive compositions that contain a photoinitiator, the curing process can be initiated by UV radiation. In one embodiment, the photoinitiator is present at a concentration of 0.1 wt % to 5 wt % based on the total weight of the organic compounds in the composition (excluding any filler). In a one embodiment, the photoinitiator comprises 0.1 wt % to 3.0 wt %, based on the total weight of the organic compounds in the composition. Photoinitiators include benzoin derivatives, benzilketals, α,α-dialkoxyacetophenones, α-hydroxyalkylphenones, α-aminoalkylphenones, acylphosphine oxides, titanocene compounds, combinations of benzophenones and amines or Michler's ketone, and the like.

In another embodiment of the invention, there are provided die-attach pastes including 0.5 weight percent to about 98 weight percent (wt %) of at least one mono-functional compound described herein, based on total weight of the composition, and 10 wt % to about 90 wt % of at least one thermosetting resin selected from acrylates, methacrylates, maleimides, vinyl ethers, vinyl esters, styrenic compounds, allyl functional compounds, epoxies, oxetanes, oxazolines, benzoxazines, and the like, based on total weight of the composition; 0 to about 90 wt % of a conductive filler; 0.1 wt % to about 5 wt % of at least one curing initiator, based on total weight of the composition; and 0.1 wt % to about 4 wt %, of at least one coupling agent, based on total weight of the composition.

Fillers contemplated for use in the practice of the present invention can be electrically conductive and/or thermally conductive, and/or fillers which act primarily to modify the rheology of the resulting composition. Examples of suitable electrically conductive fillers which can be employed in the practice of the present invention include silver, nickel, copper, aluminum, palladium, gold, graphite, metal-coated graphite (e.g., nickel-coated graphite, copper-coated graphite, and the like), and the like. Examples of suitable thermally conductive fillers which can be employed in the practice of the present invention include graphite, aluminum nitride, silicon carbide, boron nitride, diamond dust, alumina, and the like. Compounds, which act primarily to modify rheology, include silica, fumed silica, alumina, titania, calcium carbonate, and the like.

As used herein, the term “coupling agent” refers to chemical species that are capable of bonding to a mineral surface and which also contain polymerizable reactive functional group(s) so as to enable interaction with the adhesive composition. Coupling agents thus facilitate linkage of the die-attach paste to the substrate to which it is applied.

Exemplary coupling agents contemplated for use in the practice of the present invention include silicate esters, metal acrylate salts (e.g., aluminum methacrylate), titanates (e.g., titanium methacryloxyethylacetoacetate triisopropoxide), or compounds that contain a copolymerizable group and a chelating ligand (e.g., phosphine, mercaptan, acetoacetate, and the like). In some embodiments, the coupling agents contain both a co-polymerizable function (e.g., vinyl moiety, acrylate moiety, methacrylate moiety, and the like), as well as a silicate ester function. The silicate ester portion of the coupling agent is capable of condensing with metal hydroxides present on the mineral surface of substrate, while the co-polymerizable function is capable of co-polymerizing with the other reactive components of invention die-attach paste. In certain embodiments coupling agents contemplated for use in the practice of the invention are oligomeric silicate coupling agents such as poly(methoxyvinylsiloxane).

In some embodiments, both photoinitiation and thermal initiation may be desirable. For example, curing of a photoinitiator-containing adhesive can be started by UV irradiation, and in a later processing step, curing can be completed by the application of heat to accomplish a free-radical cure. Both UV and thermal initiators may therefore be added to the adhesive composition.

In general, these compositions will cure within a temperature range of 80-220° C., and curing will be effected within a length of time of less than 1 minute to 60 minutes. As will be understood by those skilled in the art, the time and temperature curing profile for each adhesive composition will vary, and different compositions can be designed to provide the curing profile that will be suited to the particular industrial manufacturing process.

In certain embodiments, the adhesive compositions may contain compounds that lend additional flexibility and toughness to the resultant cured adhesive. Such compounds may be any thermoset or thermoplastic material having a T_{g} of 50° C. or less, and typically will be a polymeric material characterized by free rotation about the chemical bonds, the presence of ether groups, and the absence of ring structures. Suitable such modifiers include polyacrylates, poly(butadiene), polyTHF (polymerized tetrahydrofuran, also known as poly(1,4-butanediol)), CTBN (carboxy-terminated butadiene-acrylonitrile) rubber, and polypropylene glycol. When present, toughening compounds may be in an amount up to about 15 percent by weight of the maleimide and other monofunctional vinyl compound.

Inhibitors for free-radial cure may also be added to the adhesive compositions and die-attach pastes described herein to extend the useful shelf life of adhesive compositions containing the mono-functional compounds. Examples of these inhibitors include hindered phenols such as 2,6-di-tert-butyl-4-methylphenol; 2,6-di-tert-butyl-4-methoxyphenol; tert-butyl hydroquinone; tetrakis(methylene(3,5-di-tert-butyl-4-hydroxyhydrocinnamate))benzene; 2,2′-methylenebis(6-tert-butyl-p-cresol); and 1,3,5-trimethyl-2,4,6-tris(3′,5′-di-tert-butyl-4-hydroxybenzyl)benzene. Other useful hydrogen-donating antioxidants include derivatives of p-phenylenediamine and diphenylamine. It is also well know in the art that hydrogen-donating antioxidants may be synergistically combined with quinones, and metal deactivators to make a very efficient inhibitor package. Examples of suitable quinones include benzoquinone, 2-tert butyl-1,4-benzoquinone; 2-phenyl-1,4-benzoquinone; naphthoquinone, and 2,5-dichloro-1,4-benzoquinone. Examples of metal deactivators include N,N′-bis(3,5-di-tert-butyl-4-hydroxyhydrocinnamoyl)hydrazine; oxalyl bis(benzylidenehydrazide); and N-phenyl-N′-(4-toluenesulfonyl)-p-phenylenediamine. Nitroxyl radical compounds such as TEMPO (2,2,6,6-tetramethyl-1-piperidnyloxy, free radical) are also effective as inhibitors at low concentrations. The total amount of antioxidant plus synergists typically falls in the range of 100 to 2000 ppm relative to the weight of total base resin. Other additives, such as adhesion promoters, in types and amounts known in the art, may also be added.

These compositions will perform within the commercially acceptable range for die attach adhesives. Commercially acceptable values for die shear for the adhesives on a 80×80 mil² silicon die are in the range of greater than or equal to 1 kg at room temperature, and greater than or equal to 0.5 kg at 240° C. Acceptable values for warpage for a 500×500 mil² die are in the range of less than or equal to 70 Nm at room temperature.

In yet another embodiment of the invention, there are provided assemblies of components adhered together employing the above-described adhesive compositions and/or die attach pastes. Thus, for example, assemblies comprising a first article permanently adhered to a second article by a cured aliquot of the above-described adhesive composition are provided. Articles contemplated for assembly employing invention compositions include memory devices, ASIC devices, microprocessors, flash memory devices, and the like.

Also contemplated are assemblies comprising a microelectronic device permanently adhered to a substrate by a cured aliquot of the above-described die attach paste. Microelectronic devices contemplated for use with invention die attach pastes include copper lead frames, Alloy 42 lead frames, silicon dice, gallium arsenide dice, germanium dice, and the like.

In still another embodiment of the present invention, there are provided methods for attaching two component parts to produce the above-described assemblies. Thus, for example, a first article can be attached to a second article, employing a method including:

(a) applying the above-described adhesive composition to the first article,

(b) bringing the first and second article into intimate contact to form an assembly wherein the first article and the second article are separated only by the adhesive composition applied in (a), and thereafter,

(c) subjecting the assembly to conditions suitable to cure the adhesive composition.

Similarly, a microelectronic device can be attached to a substrate, employing a method comprising:

(a) applying the above-described die attach paste to the substrate and/or the microelectronic device,

(b) bringing the substrate and the device into intimate contact to form an assembly wherein the substrate and the device are separated only by the die attach composition applied in (a), and thereafter,

(c) subjecting the assembly to conditions suitable to cure the die attach composition.

The following examples are intended only to illustrate the present invention and should in no way be construed as limiting the subject invention. The itaconate and fumarate compounds contemplated in this invention (see Examples 22 through 32) are often scrambled mixtures comprising at least two different alcohol starting compounds. This scrambling affords lower melting, and/or liquid monomer products, which are desirable for some applications. The structures shown for these scrambled compounds represent typically prevalent component in the mixtures. It would be well understood by those having ordinary skill in the art that the actual products generated from the use of two different alcohols in these examples would consist of a 1:2:1 mixture of a symmetric diester of a first alcohol: the scrambled diester: a symmetric diester of a second alcohol.

### EXAMPLES

### Example 1

### 3-methoxyphenylmaleimide

Toluene (100 ml), triethylamine (10 g), methanesulfonic acid (15 g) were placed into a 500 ml, single-neck flask. Maleic anhydride (21.0 g, 214 millimoles) was dissolved into this mixture. This mixture was stirred magnetically at room temperature and m-anisidine (24.67 g, 200 millimoles) was then added drop-wise over a twenty-minute period. A Dean-Stark trap and condenser were attached and the mixture was refluxed for three hours. A total of 3.7 ml of water was collected in the trap. The mixture was cooled to room temperature and the upper (toluene) phase was decanted off. The lower phase was extracted with 6×70 ml portions of fresh toluene. The collected toluene phase was passed over 27 grams of silica gel. The toluene was removed on a rotary evaporator to yield 27.3 g (67% of theory) of a clear yellow liquid. The product crystallized to a solid upon standing at room temperature. The solid melted at 75-76.5° C.

### Example 2

### 2,4,6-tribromophenylmaleimide

Into a 500 ml, single neck flask was placed 49.47 g (150 mmol) 2,4,6-tribromoaniline; 16.67 g (170 mmol) maleic anhydride; toluene (200 ml); and methanesulfonic acid (3.0 g). The 2,4,6-tribromaniline was only slightly soluble in this mixture upon stirring at room temperature. The mix was heated to reflux with a Dean-Stark trap and condenser attached. The mixture became a light red solution at reflux. The mixture was refluxed for 2.5 hours and 2.8 ml of water was collected in the trap. The residual acid was neutralized using ten grams sodium bicarbonate and two grams water. The mix was dried with six grams anhydrous magnesium sulfate and then passed over fifteen grams silica gel. The final product was recovered as a light yellow solid after removal of the toluene. It weighed 60.9 grams (99.0% of theory) and melted at 140-143.2° C.

### Example 3

### 2,6-diethylphenylmaleimide

Twenty-one grams (214 mmol) maleic anhydride, 2.14 grams methanesulfonic acid and toluene (96 ml) were placed in a single-neck, 500 ml flask. The mix was stirred magnetically and 29.8 grams (200 mmol) 2,6-diethylaniline was dripped in over ten minutes. The amic acid that formed stayed in solution. The mix was refluxed with a Dean-Stark trap and condenser attached for 2.5 hours. The water collected was equivalent to theory (3.6 ml). The toluene phase was passed over 33 grams silica gel. The toluene was removed to yield 45.6 g (99.6% of theory) of a light pink solid. It melted at 72-74° C.

### Examples 4-12

Additional mono-maleimides were prepared using a method similar to that outlined in the above examples. A summary of all the mono-maleimide examples is presented in Table 1.

TABLE 1
Synthesis Results for and Properties of Mono-Maleimide Compounds

| | | | | Residue | | |
|---|---|---|---|---|---|---|
| | | | Melting | (%) | T_{dec.} | |
| EXAMPLE | COMPOUND | Yield (%) | Point (° C.) | at 300° C. | (° C.) | T_{g} (° C.) |
| 1 | 3-methoxy- | 67.2 | 75-76.5 | 99.4 | 408 | 234 |
| | phenylmaleimide | | | | | |
| 2 | 2,4,6-tribromo- | 99 | 140-143.2 | 94.6 | 456 | 216 |
| | phenylmale-imide | | | | | |
| 3 | 2,6-diethylphenyl- | 99.6 | 72-74 | 95.4 | 438 | 260 |
| | maleimide | | | | | |
| 4 | 3-methylphenyl- | 91 | 38-41.7 | 95.9 | 441 | 224 |
| | maleimide | | | | | |
| 5 | 2,4-dimethylphenyl- | 96 | 72.6-76.9 | 97.8 | 451 | 274 |
| | maleimide | | | | | |
| 6 | cyclohexylmaleimide | 64 | 88.4-90.8 | 89.5 | 470 | 260 |
| 7 | 2-methylphenyl- | 94.5 | 68.8-73.2 | 94.2 | 443 | 277 |
| | maleimide | | | | | |
| 8 | 2,6-diisopropylphenyl- | 99 | 112.4-116.4 | 87.5 | 435 | 127 |
| | maleimide | | | | | |
| 9 | 2-phenoxyphenyl- | 91.3 | 90.5-92.7 | 91.9 | 450 | 189 |
| | maleimide | | | | | |
| 10 | 2-ethyl-6- | 99 | 87-90.7 | 95.1 | 450 | 288 |
| | methylphenyl- | | | | | |
| | maleimide | | | | | |
| 11 | 2,6-dimethylphenyl- | 94 | 107.7-111.6 | 93.0 | 448 | 289 |
| | maleimide | | | | | |

Note:
The TGA residual weight and decomposition onsets were determined for all samples with 2% (by weight) added dicumyl peroxide.
The ramp rate for the TGA was 10° C. per minute, and the furnace purge gas was air.

### Example 13

### Synthesis of tricyclodecanemethanol acrylate

To a 500 ml flask equipped with a Dean-Stark trap was added tricyclodecyl methanol (50 g, 300 mmol), acrylic acid (23.8 g, 330 mmol), heptane (250 ml), methanesulfonic acid (3.0 g), and MEHQ (132 mg). The mixture was refluxed for 65 minutes under a mild air sparge, at which point 5.3 ml water (theoretical amount 5.4 ml) had collected in the Dean-Stark trap. The mixture was washed with sodium bicarbonate, dried over magnesium sulfate, and finally passed over silica gel. The solvent was removed by rotary evaporation to afford the product (64.3 g, 97.3% yield).

### Example 14

### Synthesis of tricyclodecanemethanol methacrylate

This compound was synthesized as described in Example 13, with methacrylic acid substituted for acrylic acid. The product was obtained with 97.7% yield.

### Example 15

### Synthesis of isobornylcyclohexyl acrylate

To a 500 ml flask equipped with a Dean-Stark trap was added isobornylcyclohexanol (9.8 g, 41 mmol), acrylic acid (3.6 g, 50 mmol), heptane (200 ml), methanesulfonic acid (0.3 g), and MEHQ (28 mg). The mixture was refluxed for 4.5 hours under a mild air sparge, at which point 5.3 ml water (theoretical amount 5.4 ml) had collected in the Dean-Stark trap. The mixture was washed with sodium bicarbonate, dried over magnesium sulfate, and finally passed over silica gel. The solvent was removed by rotary evaporation to afford the product (10.7 g, 90% yield).

### Example 16

### Thermal Data

Two adhesive compositions were prepared. Composition A and Composition B both contained proprietary thermosetting resins with a free-radical curing initiator. 2-methylphenylmaleimide and 2,4-dimethylphenylmaleimide were combined in a 1:1 mol/mol ratio to form a eutectic mixture and then this mixture was incorporated into Composition B at 16.7 wt %. The data are presented in Table 2 and show a significant increase in T_{g} value without a significant increase in modulus.

TABLE 2
Thermal Data

| | Composition A | Composition B |
|---|---|---|
| T_{g} | 82° C. | 129° C. |
| α₁ (ppm/° C.) | 45 | 55 |
| α₂ | 117 | 127 |

### Example 17

### Thermal Data

Two adhesive compositions were prepared. Composition C and Composition D both contained proprietary thermosetting resins with a free-radical curing initiator. 2-methylphenylmaleimide and 2,4-dimethylphenylmaleimide were combined in a 1:1 mol/mol ratio to form a eutectic mixture and then this mixture was incorporated into Composition C at 10 wt % and Composition D at 50wt %. The data are presented in Table 2 and demonstrate the dramatically increased T_{g} values that can be obtained by increasing the amount of monofunctional monomers in the adhesive composition. In addition, the data show that CTE values can be decreased by the use of the monofunctional monomers described herein.

TABLE 3
Thermal Data

| | Composition C | Composition D |
|---|---|---|
| T_{g1} (° C.) | −1.4 | 50.8 |
| T_{g2} | 62 | 184 |
| α₁ (ppm/° C.) | 84.6 | 72.5 |
| α₂ | 160 | 140 |

### Example 18

### Thermal Data

Table 4 set forth below presents a series of data indicating melting points of mixtures of some exemplary monofunctional monomers according to the invention. The data was obtained by differential scanning calorimetry (DSC).

TABLE 4
Thermal Data

| | 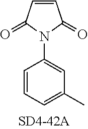 | 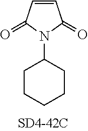 [SMILES: O=C1C=CC(=O)N1C1CCCCC1] | 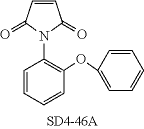 [SMILES: O=C1C=CC(=O)N1c1ccccc1Oc1ccccc1] | 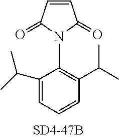 [SMILES: CC(C)c1cccc(C(C)C)c1N1C(=O)C=CC1=O] | 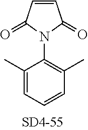 | 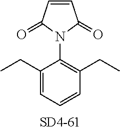 [SMILES: CCc1cccc(CC)c1N1C(=O)C=CC1=O] |
|---|---|---|---|---|---|---|
| SD4-42A | 38.12 | | | | | |
| | (41.67) | | | | | |
| SD4-42C | 59.02 | 88.36 | | | | |
| | (66.56) | (90.82) | | | | |
| SD4-46A | 43.45 | 63.76 | 90.50 | | | |
| | (60.63) | (73.03) | (92.66) | | | |
| SD4-47B | 45.50 | 59.15 | 68.87 | 112.43 | | |
| | (55.91) | (64.82) | (76.78) | (116.44) | | |
| | | 163.23 | | | | |
| | | (198.14) | | | | |
| SD4-55 | LIQUID | 43.75 | 49.21 | 72.10 | 66.52 | |
| | | (53.75) | (57.73) | (81.04) | (74.06) | |
| SD4-61 | LIQUID | 54.66 | 56.31 | 59.27 | 59.91 | 85.66 |
| | | (63.78) | (65.29) | (66.50) | (67.57) | (90.68) |
| SD4-64 | LIQUID | 62.28 | 60.80 | 62.68 | 45.90 | 74.73 |
| | | (66.81) | (68.34) | (68.39) | (59.10) | (81.93) |
| | | | | | | 257.24 |
| | | | | | | (277.75) |
| ML17-22A | 47.22 | 51.27 | 50.53 | 54.23 | 40.64 | 47.44 |
| | (48.64) | (66.98) | (58.76) | (61.49) | (47.13) | (62.36) |
| ML17-23B | 35.99 | 51.14 | 53.60 | 53.98 | 39.42 | 47.51 |
| | (38.40) | (64.49) | (62.52) | (59.18) | (46.95) | (56.37) |
| ML17-30A | 39.48 | 52.68 | 39.18 | 49.85 | 36.24 | 42.82 |
| | (47.58) | (62.96) | (51.42) | (56.55) | (42.25) | (55.45) |
| | | | (61.26) | | | |
| SD18-44B | LIQUID | 70.31 | 74.53 | 88.98 | 56.20 | 67.25 |
| | | (78.91) | (79.49) | (94.25) | (60.68) | (73.04) |
| | | (99.46) | (99.53) | (106.37) | (98.68) | (99.86) |

| | 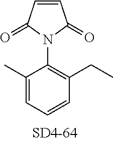 [SMILES: CCc1cccc(C)c1N1C(=O)C=CC1=O] | 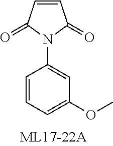 | 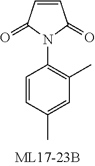 | 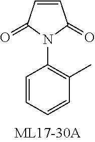 | 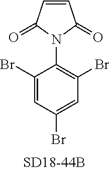 |
|---|---|---|---|---|---|
| SD4-42A | | | | | |
| SD4-42C | | | | | |
| SD4-46A | | | LEGEND | | |
| SD4-47B | | | ##.## = onset | | |
| | | | (##.##) = peak | | |
| | | | ##.## = 2nd onset | | |
| | | | (##.##) = 2nd peak | | |
| SD4-55 | | | | | |
| SD4-61 | | | | | |
| SD4-64 | 107.72 | | | | |
| | (111.58) | | | | |
| ML17-22A | 47.50 | 69.37 | | | |
| | (59.13) | (76.30) | | | |
| ML17-23B | 50.86 | 44.75 | 72.55 | | |
| | (57.30) | (45.76) | (76.94) | | |
| ML17-30A | 44.02 | 39.47 | 36.34 | 73.10 | |
| | (54.63) | (42.06) | (40.71) | (81.89) | |
| SD18-44B | 76.60 | 57.36 | 59.23 | 55.56 | |
| | (82.55) | (64.08) | (66.04) | (61.63) | 140.00 |
| | (98.55) | (100.39) | (97.75) | (97.45) | (143.15) |

### Example 19

### Synthesis of dimethylphenylitaconimide

Itaconic anhydride (11.21 g, 100 mmol) and 150 ml toluene were placed into a 500 ml, single neck flask. This mixture was stirred at room temperature and 12.12 g (100 mmol) of mixed xylidines was added over fifteen minutes. The mixture became a pink slurry of the amic acid in toluene. Methanesulfonic acid (1.0 g) was added and a Dean-Stark trap and condenser were attached. The mixture was refluxed for twenty-four hours and 1.7 ml (theory=1.8) of water was collected in the trap. The solution was cooled and neutralized with ten grams sodium bicarbonate and two grams water.

The solution was dried with eight grams of anhydrous magnesium sulfate and then passed over twelve grams of silica gel. The toluene was removed to give 19.7 grams (91.5% of theory) of a viscous, light brown liquid. A portion of this monomer was catalyzed with two percent dicumyl peroxide and was found to have 92.6% residual weight at 300° C. and a decomposition onset of 348° C.

### Example 20

### Synthesis of xylidinemaleimide

A 500 ml flask was charged with 43.15 g (440 mmole) maleic anhydride, 200 ml toluene and 2.5 g methanesulfonic acid. This mixture was stirred at room temperature until the maleic anhydride was completely dissolved. Mixed xylidines (48.48 g, 400 mmole) were then dripped in over the course of twenty minutes. The mix became a slurry, but it could still be stirred magnetically. A Dean-Stark trap and condenser were attached and the mix was brought to reflux. Reflux was continued for 14 hours and 6.8 ml water (7.2 ml is the theoretical amount) was collected.

The mixture was cooled to room temperature and then neutralized with ten grams sodium bicarbonate plus four grams water. It was dried with 12 grams anhydrous magnesium sulfate and then passed over 20 g silica gel. The toluene was removed to give 72.85 g (90.5%) of a moderately viscous, red liquid. A portion of this liquid was catalyzed with 2% dicumyl peroxide. The residual weight at 300° C. was 91.2% and the decomposition onset was 440° C.

### Example 21

### Synthesis of 2,4-di-tert-butylphenoxyethanol

The title compound 1 (shown below) was synthesized as follows.

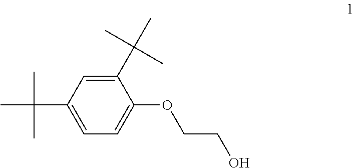 [SMILES: CC(C)(C)c1ccc(OCCO)c(C(C)(C)C)c1]

2,4-di-tert-butylphenol (86.8 g, 417 mmol), ethylene carbonate (42.0 g, 477 mmol), 200 mg of 4-dimethylaminopyridine, and a stir bar were added to a 3-neck, 500 ml flask. An N₂-inlet was placed into one neck. A temperature controller was secured to another neck. A condenser and bubbler were attached to the third neck. The reaction was allowed to run for 16 hours in an oil bath controlled at 140° C. Significant CO₂ evolution was observed during the first few hours of the reaction. The condenser and bubbler were removed. The mixture was sparged with N₂ at 140° C. for an hour to remove residual, un-reacted ethylene carbonate.

The product solidified into a light brown wax at room temperature. 99.7 g (95.5% of theory) was collected. The compound was subjected to thermogravimetric analysis (TGA). The retained weight at 100° C. (TGA ramp rate=10° C./min., air purge) was 99.7% and the decomposition/evaporation onset was at 154° C. Infrared spectrum included absorptions at 3372, 2952, 2869, 1604, 1495, 1458, 1402, 1361, 1236, 1094, 923, 889, 809, and 726 wavenumbers.

### Example 22

### Synthesis of butenedioic acid 2-(2,4-di-tert-butylphenoxy)ethyl ester-4-octahydro-4,7-methano-inden-5-yl ester

The title compound 2 (shown below) was synthesized as follows.

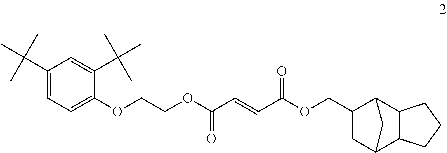 [SMILES: CC(C)(C)c1ccc(OCCOC(=O)/C=C/C(=O)OCC2CC3CC2C2CCCC32)c(C(C)(C)C)c1]

The alcohol 1 obtained as described in Example 21, above, (25.0 g, 100 mmol), tricyclodecanemethanol (16.6 g, 100 mmol), fumaric acid (11.6 g, 100 mmol), toluene (150 ml), and methanesulfonic acid (1.5 g) were added to a 500 ml flask. A stir bar was added to the flask. A trap and condenser were attached to the flask. The solution stirred at reflux for 4.75 hours. The reflux of the reaction mixture generated 3.7 ml of H₂O (3.6 ml was expected). The solution was cooled and then neutralized and with sodium bicarbonate (12 g) and H₂O (3 g). When neutralization was complete, the solution was dried with MgSO₄ (8 g). It was then passed through silica gel (20 g) along with toluene washings. The toluene was removed by rotary evaporation at 75° C. under water aspirator vacuum followed by sparge with clean, dry air at 90° C.

The reaction yielded 48.1 g of a very viscous, amber liquid. The retained weight via TGA at 200° C. (TGA ramp rate=10° C./min., air purge) was 99.5%, and the decomposition onset was at 291° C. Fourier transform infrared spectroscopy (FTIR) was performed on the final compound and it was found to have major absorptions at 2952, 2874, 1722, 1645, 1498, 1446, 1361, 1293, 1255, 1151, 1097, 979, 891, and 809 wavenumbers.

### Example 23

### Synthesis of butenedioic acid bis-(2,4-di-tert-butylphenoxy)ethyl ester

The title compound 3 (shown below) was synthesized as follows.

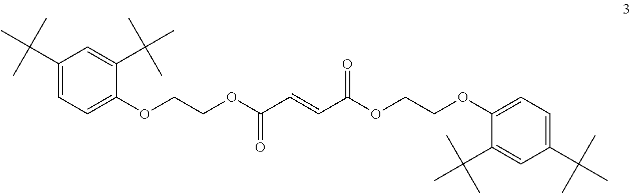 [SMILES: CC(C)(C)c1ccc(OCCOC(=O)/C=C/C(=O)OCCOc2ccc(C(C)(C)C)cc2C(C)(C)C)c(C(C)(C)C)c1]

The alcohol 1 obtained as described in Example 21, above, (25.0 g, 100 mmol), furmaric acid (5.8 g, 50 mmol), toluene (125 ml), and methanesulfonic acid (1.0 g) were all charged into a 500 ml, single-neck flask. A stir bar was added to the flask. A trap and condenser were added to the flask. This reaction was quite slow compared to the lower molecular weight fumarate 2 described in Example 22, above. It required 19 hours of reflux for the reaction to yield the theoretical 1.8 ml of H₂O. The solution was neutralized and with sodium bicarbonate (12 g) and H₂O (3 g). When neutralization was complete, the solution was dried with MgSO₄ (8 g). It was then passed through silica gel (2×15 g). The toluene was removed by rotary evaporation at 75° C. followed by air sparge at 90° C.

A total of 27.3 g (94.0% of theory) of this compound was collected. The reaction product was a very viscous, tacky, light brown liquid that crystallized upon standing. The retained weight via TGA at 200° C. (TGA ramp rate=10° C./min., air purge) was 99.6%. A DSC (differential scanning calorimeter) run was conducted (ramp rate=2° C./min., air purge) on a sample of this material. The melt via DSC was observed to occur with an onset of 83.2° C. and a peak of 86.8° C. FTIR was performed on the final compound and it was found to have major absorptions at 2952, 2870, 1728, 1650, 1497, 1458, 1361, 1290, 1232, 1152, 1096, 1044, 979, 891, and 809 wavenumbers.

### Example 24

### Synthesis of [2,4-di-tert-butyl-1-(2-oxyethoxy)benzene]-yl-2-methylene-4-oxo-butyric acid phenethyl ester

The title compound 4 (shown below) was synthesized as follows.

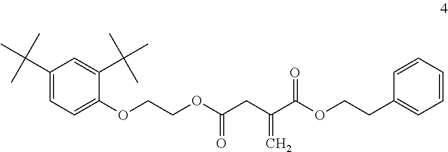 [SMILES: C=C(CC(=O)OCCOc1ccc(C(C)(C)C)cc1C(C)(C)C)C(=O)OCCc1ccccc1]

The alcohol 1 obtained as described in Example 21, above (25.0 g, 100 mmol), 2-phenylethanol (12.2 g, 100 mmol), itaconic acid (13.0 g, 100 mmol), toluene (150 ml), and methanesulfonic acid (2.0 g) were added to a 500 ml flask. A stir bar was added to the flask. A trap and condenser were added to the flask. The solution was refluxed for 6 hours and generated 3.5 ml of H₂O. The solution was neutralized and with sodium bicarbonate (12 g) and H₂O (3 g). When neutralization was complete, the solution was dried with MgSO₄ (8 g). It was then passed through silica gel (20 g). The toluene was removed by rotary evaporation at 75° C. followed by air sparge at 90° C.

The reaction product yielded 44.3 g of a golden yellow, moderately viscous liquid. The retained weight via TGA at 200° C. (TGA ramp rate=10° C./min., air purge) was 98.9% and a decomposition onset of 276° C. FTIR was performed on the final compound and it was found to have major absorptions at 2956, 1718, 1498, 1236, 1146, 1096, 813, 749, and 699 wavenumbers.

### Example 25

### Synthesis of [2,4-di-tert-butyl-1-(2-oxyethoxy)benzene]-yl-2-methylene-4-oxo-butyric acid phenoxyethyl ester

The title compound 5 (shown below) was synthesized as follows.

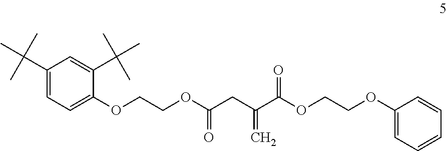 [SMILES: C=C(CC(=O)OCCOc1ccc(C(C)(C)C)cc1C(C)(C)C)C(=O)OCCOc1ccccc1]

The alcohol 1 obtained as described in Example 21, above (25.0 g, 100 mmol), 2-phenoxyethanol (13.8 g, 100 mmol), itaconic acid (13.0 g, 100 mmol), toluene (150 ml), and methanesulfonic acid (2.0 g) were all added to a 500 ml, one-neck flask. A stir bar was added to the flask. A trap and condenser were attached to the flask. The solution was refluxed for 7 hours and 3.5 ml of H₂O (theoretical=3.6) was collected. The solution was neutralized and with sodium bicarbonate (12 g) and H₂O (3 g). When neutralization was complete, the solution was dried with MgSO₄ (8 g). It was then passed over silica gel (20 g) along with toluene rinses. The toluene was removed by rotary evaporation at 75° C. and air sparge at 90° C.

The reaction product yielded 38.7 g of a very viscous, amber liquid. The retained weight via TGA at 200° C. (TGA ramp rate=10° C./min., air purge) and catalyzed with 2% dicumyl peroxide was 95.6% and a decomposition onset of 256° C. FTIR was performed on the final compound and it was found to have major absorptions at 2955, 2869, 1738, 1719, 1600, 1497, 1456, 1239, 1150, 1096, 1049, 949, 813, 736, and 692 wavenumbers.

### Example 26

### Synthesis of butenedioic acid 2-(2,4-di-tert-butylphenoxy)ethyl ester-phenethyl ester

The title compound 6 (shown below) was synthesized as follows.

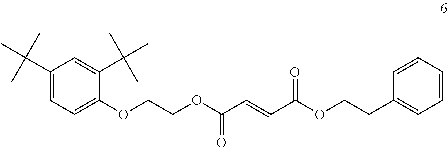 [SMILES: CC(C)(C)c1ccc(OCCOC(=O)/C=C/C(=O)OCCc2ccccc2)c(C(C)(C)C)c1]

The alcohol 1 obtained as described in Example 21, above (25.0 g, 100 mmol), 2-phenylethanol (12.2 g, 100 mmol), fumaric acid (11.6 g, 100 mmol), toluene (150 ml), and methanesulfonic acid (2.0 g) were added to a 500 ml, one-neck flask. A magnetic stir bar was added to the flask. A trap and condenser were attached to the flask. The reaction was complete after 4.25 hours of reflux and 3.7 mL of H₂O was collected. The solution was neutralized and with sodium bicarbonate (12 g) and H₂O (3 g). When neutralization was complete, the solution was dried with MgSO₄ (8 g). It was then passed through a bed of silica gel (15 g) along with toluene rinses. The toluene was removed by rotary evaporation at 75° C. and air sparge at 90° C.

The reaction product was recovered as 45.3 g (100.0% of theory) of a very viscous, amber liquid. The retained weight via TGA at 200° C. (TGA ramp rate=10° C./min., air purge) was 98.9% with a decomposition onset of 260° C. FTIR was performed on the final compound and it was found to have major absorptions at 2959, 1723, 1647, 1498, 1455, 1362, 1295, 1255, 1153, 1097, 979, 810, 747, and 699 wavenumbers.

### Example 27

### Synthesis of butenedioic acid octahydro-4,7-methano-inden-5-ylmethyl ester-phenethyl ester

The title compound 7 (shown below) was synthesized as follows.

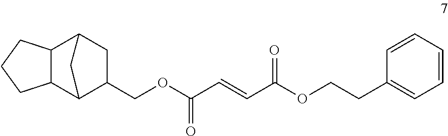 [SMILES: O=C(/C=C/C(=O)OCC1CC2CC1C1CCCC21)OCCc1ccccc1]

Tricyclodecane methanol (33.3 g, 200 mmol), 2-phenylethanol (24.4 g, 226 mmol), fumaric acid (23.2 g, 200 mmol), toluene (200 ml), and methanesulfonic acid (3.0 g) were all added to a 500 ml, one-neck flask. A magnetic stir bar was added to the flask. A trap and condenser was attached to the flask. The reaction was complete after 3.25 hours of reflux and 7.2 ml (equivalent to theory) of H₂O was collected. The solution was neutralized and with sodium bicarbonate (15 g) and H₂O (4 g). When neutralization was complete, the solution was dried with MgSO₄ (10 g). The mix was then passed through silica gel (25 g). The toluene was removed by rotary evaporation at 75° C. and air sparge at 90° C.

The reaction product yielded 73.7 g (100.0% of theory) of a moderately viscous liquid that crystallized into a slushy semi-solid. The retained weight via TGA at 200° C. (TGA ramp rate=10° C./min., air purge) was 99.9% and a decomposition onset of 238° C. FTIR was performed on the final compound and it was found to have major absorptions at 2489, 1720, 1644, 1454, 1386, 1291, 1235, 1148, 1003, 978, 748, and 698 wavenumbers.

### Example 28

### Synthesis of butenedioic acid octahydro-4,7-methano-inden-5-ylmethyl ester-phenoxyethyl ester

The title compound 8 (shown below) was synthesized as follows.

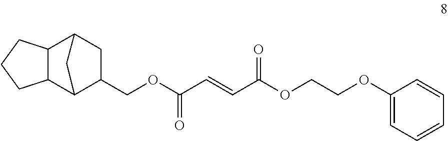 [SMILES: O=C(/C=C/C(=O)OCC1CC2CC1C1CCCC21)OCCOc1ccccc1]

Tricyclodecane methanol (16.6 g, 100 mmol), 2-phenoxyethanol (13.8 g, 100 mmol), fumaric acid (11.6 g, 100 mmol), toluene (150 ml), and methanesulfonic acid (2.0 g) were all charged into a 500 ml, one-neck flask. A magnetic stir bar was added to the flask. A trap and condenser were attached to the flask. The reaction generated 3.7 ml of H₂O. The solution was then neutralized and with sodium bicarbonate (12 g) and H₂O (3 g), which turned the peachy solution to a beige color. When neutralization was complete, the solution was dried with MgSO₄ (8 g). It was then passed over silica gel (25 g). The toluene was removed by rotary evaporation at 75° C. followed by an air sparge at 90° C.

The reaction product yielded 28.7 g (74.6% of theory) of a soft, waxy, white solid. The retained weight via TGA at 200° C. (TGA ramp rate=10° C./min., air purge) was 99.9% and a decomposition onset of 340° C. An FTIR scan was performed on the final compound and it was found to have major absorptions at 2944, 2874, 1718, 1645, 1599, 1496, 1289, 1150, 977, 752, and 690 wavenumbers.

### Example 29

### Synthesis of 2-methylenesuccinic acid-4-(octahydro-4,7-methano-inden-5-ylmethyl)ester-phenethyl ester

The title compound 9 (shown below) was synthesized as follows.

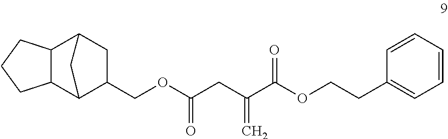 [SMILES: C=C(CC(=O)OCC1CC2CC1C1CCCC21)C(=O)OCCc1ccccc1]

Tricyclodecane methanol (16.6 g, 100 mmol), 2-phenylethanol (12.2 g, 100 mmol), itaconic acid (13.0 g, 100 mmol), toluene (150 ml), and methanesulfonic acid (2.0 g) were added to a 500 ml flask. A stir bar was added to the flask. A trap and condenser were attached to the flask. After 3 hours of reflux, 3.5 ml (3.6=theory) of H₂O was collected. The solution was neutralized and with sodium bicarbonate (12 g) and H₂O (3 g). When neutralization was complete, the solution was dried with MgSO₄ (8 g). It was then passed over silica gel (20 g) along with toluene rinses. The toluene was removed by rotary evaporation and air sparge at 75° C.

The reaction product yielded 36.7 g of a very light yellow, low viscosity liquid. The retained weight via TGA at 200° C. (TGA ramp rate=10° C./min., air purge) was 99.5%. An FTIR scan performed on the final compound showed it to have major absorptions at 2941, 1719, 1648, 1454, 1314, 1182, 1144, 1006, 950, 814, 747, and 698 wavenumbers.

### Example 30

### Synthesis of 2-methylenesuccinic acid-4-(octahydro4,7-methano-inden-5-ylmethyl)ester)-phenoxyethyl ester

The title compound 10 (shown below) was synthesized as follows.

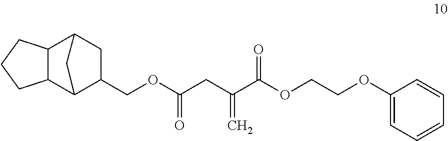 [SMILES: C=C(CC(=O)OCC1CC2CC1C1CCCC21)C(=O)OCCOc1ccccc1]

Tricyclodecane methanol (16.6 g, 100 mmol), 2-phenoxyethanol (13.8 g, 100 mmol), itaconic acid (13.0 g, 100 mmol), toluene (150 ml), and methanesulfonic acid (2.0 g) were all added to a 500 ml flask. A stir bar was added to the flask. A trap and condenser were added to the flask. After 3.5 hours of reflux, 3.9 ml of H₂O had been collected. The solution was neutralized and with sodium bicarbonate (12 g) and H₂O (3 g). When neutralization was complete, the solution was dried with MgSO₄ (8 g). It was then passed over silica gel (20 g) along with toluene rinses. The toluene was removed by rotary evaporation and air sparge at 75° C.

The final product was recovered as 37.1 g (93.2% of theory) of a light yellow liquid. The retained weight via TGA at 200° C. (TGA ramp rate=10° C./min., air purge) was 99.0%. FTIR was performed on the final compound and it was found to have major absorptions at 2946, 1717, 1641, 1497, 1314, 1244, 1145, 1085, 948, 814, 752, and 691 wavenumbers.

### Example 31

### Synthesis of 2-methylenesuccinic acid-1-(octahydro-4,7-methano-inden-5-ylmethyl)ester-4-(octahydro-4,7-methano-inden-5-ylmethyl)ester

The title compound 11 (shown below) was synthesized as follows.

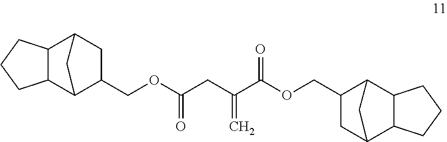 [SMILES: C=C(CC(=O)OCC1CC2CC1C1CCCC21)C(=O)OCC1CC2CC1C1CCCC21]

Tricyclodecane methanol (65.6 g, 400 mmol), itaconic acid (26.0 g, 200 mmol), heptane (60 mL), butylated hydroxytoluene (43 mg), and methanesulfonic acid (2.0 g) were added to a 2-neck, 500 mL flask. A stir bar was added to the flask. A trap and condenser were attached to one of the necks and a gentle air sparge was introduced under the solution through the other neck. The solution was refluxed for 5.75 hours and 7.0 ml of H₂O was collected. The solution was diluted with additional heptane (300 ml). The solution was then neutralized and with sodium bicarbonate (12 g) and H₂O (4 g). When neutralization was complete, the solution was dried with MgSO₄ (8 g). It was then passed through silica gel (25 g). The heptane was removed via rotary evaporation and air sparge at 70° C.

The reaction yielded 76.9 g (90.1%) of a moderately viscous, amber liquid. The retained weight via TGA at 200° C. (TGA ramp rate=10° C./min., air purge) was 99.9%. An FTIR was performed on the final compound and it was found to have major absorptions at 2944, 2875, 1728, 1640, 1471, 1312, 1178, 1140, 1006, and 814 wavenumbers.

### Example 32

### Synthesis of 2-methylenesuccinic acid-4-phenethyl ester-1-(2-phenoxyethyl)ester

The title compound 12 (shown below) was synthesized as follows.

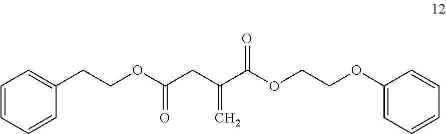 [SMILES: C=C(CC(=O)OCCc1ccccc1)C(=O)OCCOc1ccccc1]

2-Phenylethanol (12.2 g, 100 mmol), 2-phenoxyethanol (13.8 g, 100 mmol), itaconic acid (13.0 g, 100 mmol), toluene (150 ml), and methanesulfonic acid (1.5 g) were added to a 500 ml, one-neck flask. A stir bar was added to the flask. A trap and condenser were attached to the flask. The mixture was stirred and refluxed for 5 hours to collect 3.5 ml of H₂O. The solution was neutralized and with sodium bicarbonate (12 g) and H₂O (3 g). When neutralization was complete, the solution was dried with MgSO₄ (8 g). It was then passed through a bed of silica gel (20 g). The toluene was removed by rotary evaporation and air sparge at 75° C.

The recovered yield of product was 33.3 g (93.8% of theory). It was a fairly low viscosity, light amber liquid. The retained weight of the neat compound via TGA at 200° C. (TGA ramp rate=10° C./min., air purge) was 99.0% and it had a decomposition onset at 252° C. An FTIR was performed on the final compound and it was found to have major absorptions at 1721, 1598, 1495, 1316, 1242, 1143, 948, 814, 750, and 690 wavenumbers.

### Example 33

### Synthesis of 2-(2-methylacryloxy)-succinic acid bis-(octahydro-4,7-methanoinden-5-ylmethyl)ester

The title compound 13 (shown below) was synthesized as follows.

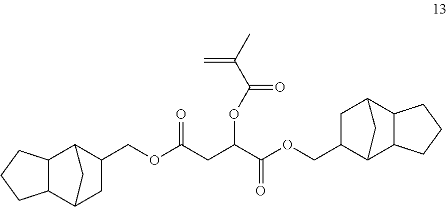 [SMILES: C=C(C)C(=O)OC(CC(=O)OCC1CC2CC1C1CCCC21)C(=O)OCC1CC2CC1C1CCCC21]

Tricyclodecanemethanol (33.3 g, 200 mmol), malic acid (13.4 g, 100 mmol), 100 ml of toluene, and a stir bar were placed in a 2-neck, 500 ml flask. A Dean-Stark trap and condenser were attached to one neck. A temperature probe was secured to the other neck. The mixture was heated to 115° C. and refluxed for 78 hrs. 3.5 ml of water (3.6 ml=theory) was collected in the trap. After the solution had cooled to room temperature, methacrylic anhydride (16.9 g, 110 mmol) and 150 mg of 4-dimethylaminopyridine were added to the flask. The mixture was stirred at 70° C. for 17 hrs. FTIR showed the disappearance of —OH. 10 ml of methanol was added to the mixture and the solution was stirred at 50° C. for an additional 6 hrs. FTIR showed the disappearance of all residual anhydride. The solution was diluted with 100 ml of toluene. The solution was neutralized with 15 g of sodium carbonate and 4 g of water. It was dried with 12 g of magnesium sulfate. The solution was passed through 20 g of silica. The toluene was then removed via rotary evaporation followed by a sparge at 70° C. with clean dry air.

A total of 46.0 g of a light brown liquid was collected. The compound was subjected to TGA. The loss weight at 100° C. (TGA ramp rate=10° C./min, air purge) was 1.1%. An FTIR trace run on this product included prominent absorptions at 2955, 2875, 1732, 1638, 1453, 1277, 1166, 1105, and 1004 wavenumbers.

While this invention has been described with respect to these specific examples, it should be clear that other modifications and variations would be possible without departing from the spirit of this invention.

What is claimed is:

1. An adhesive composition comprising:
(a) a thermosetting resin; and
(b) at least one monomer having the structure selected from the group consisting of: 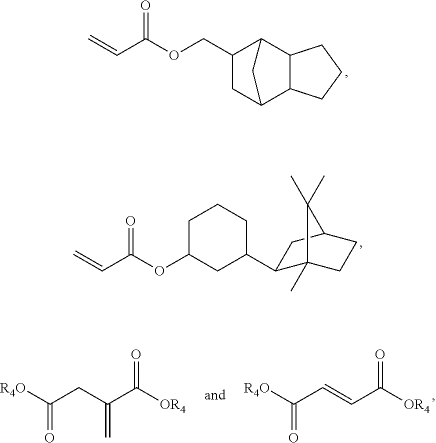
wherein:
each R₄ is independently selected from the group consisting of H, alkyl, alkoxy, aryloxy, halide, —O(CO)—R₃ and any of the following: 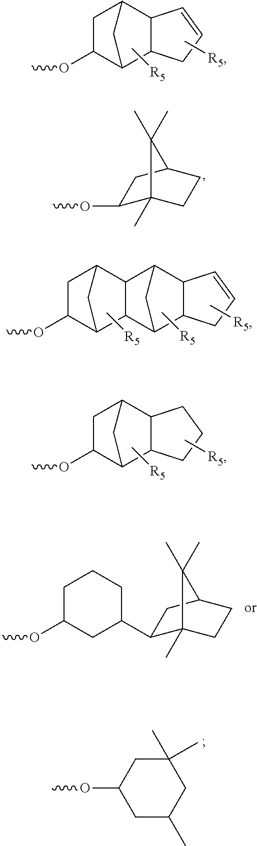
wherein in R₄:
R₃ is selected from the group consisting of a C₁-C₁₀ alkyl and any of the following: 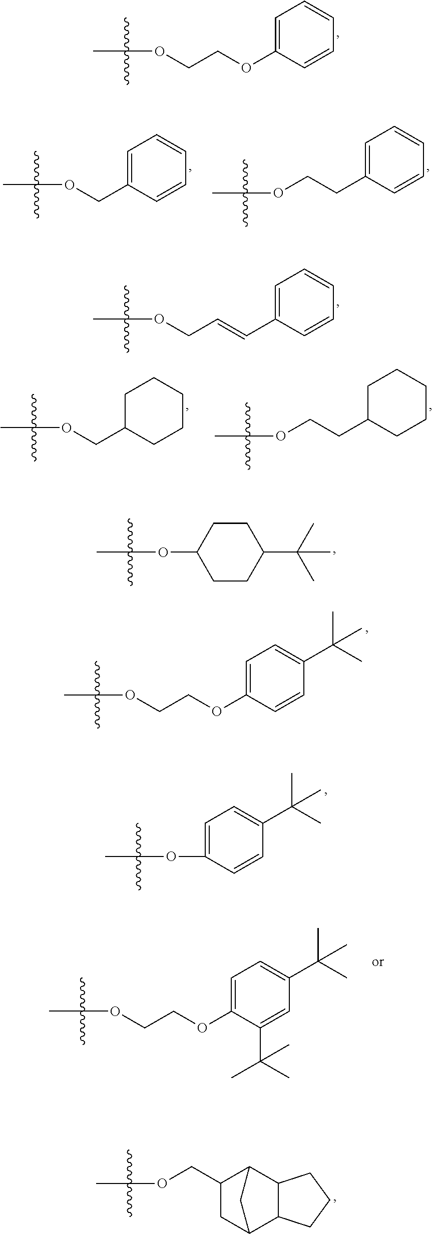
and
further in R₄, each R₅ is independently selected from the group consisting of H and methyl.

2. The adhesive composition of claim 1, wherein each R4 is independently selected from the group consisting of methyl, ethyl, propyl, isopropyl, butyl, isobutyl, tert-butyl, phenyl and cyclohexyl.

3. The adhesive composition of claim 1, wherein each R₄ is independently selected from the group consisting of methoxy, ethoxy, propyloxy and phenoxy.

4. The adhesive composition of claim 1, wherein each R₄ is independently selected from the group consisting of fluorine, chlorine and bromide.

5. The adhesive composition of claim 1, wherein each R₄ is independently selected from the group consisting of —O(CO)—R₃, wherein R₃ is C₁-C₅ alkyl.

6. The adhesive composition of claim 1, wherein the composition has a T_{g} of at least 30° C.

7. The adhesive composition of claim 1, wherein the composition has a T_{g} of at least 100° C.

8. The adhesive composition of claim 1, wherein the composition has a T_{g} of at least 150° C.

9. The adhesive composition of claim 1, wherein the composition has a T_{g} of at least 200° C.

10. The adhesive composition of claim 1, wherein the thermosetting resin is selected from the group consisting of acrylates, methacrylates, maleimides, vinyl ethers, vinyl esters, styrenic compounds, allyl functional compounds, epoxies, oxetanes, oxazolines and benzoxazines.

11. The adhesive composition of claim 1, further comprising a filler.

12. The adhesive composition of claim 11, wherein the filler is conductive.

13. The adhesive composition of claim 12, wherein the filler is thermally conductive.

14. The adhesive composition of claim 12, wherein the filler is electrically conductive.

15. A method for increasing T_{g} of a thermosetting resin without substantially increasing modulus of the resin, comprising incorporating into the thermosetting resin at least one monomer of claim 1.

16. The adhesive composition of claim 1, wherein each R₄ is independently selected from the group consisting of methyl, ethyl, propyl, isopropyl, butyl, isobutyl, tert-butyl, phenyl and cyclohexyl.

17. The adhesive composition of claim 15, wherein each R₄ is independently selected from the group consisting of methoxy, ethoxy, propyloxy and phenoxy.

18. The adhesive composition of claim 15, wherein each R₄ is independently selected from the group consisting of fluorine, chlorine and bromide.

19. The adhesive composition of claim 15, wherein each R₄ is independently selected from the group consisting of —O(CO)—R₃, wherein R₃ is C₁-C₅ alkyl.

20. The adhesive composition of claim 1, wherein the monomer is selected from the group consisting of tricyclodecanemethanol acrylate, tricyclodecanemethanol methacrylate, isobornylcyclohexyl acrylate, and any of 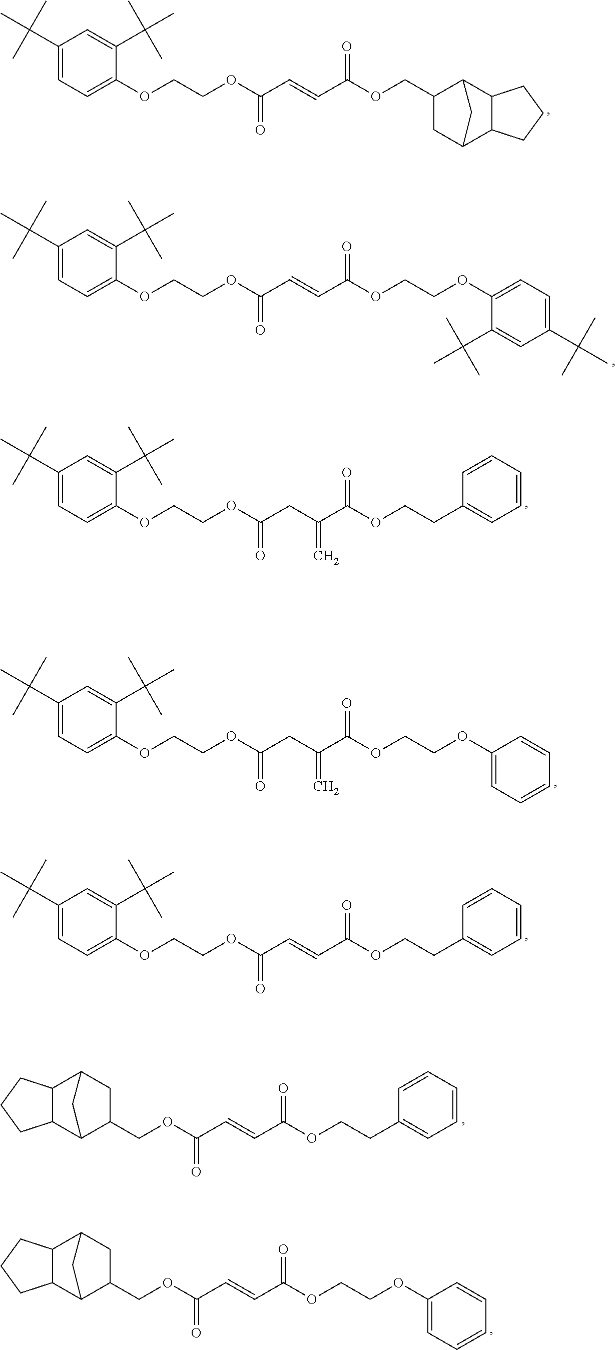 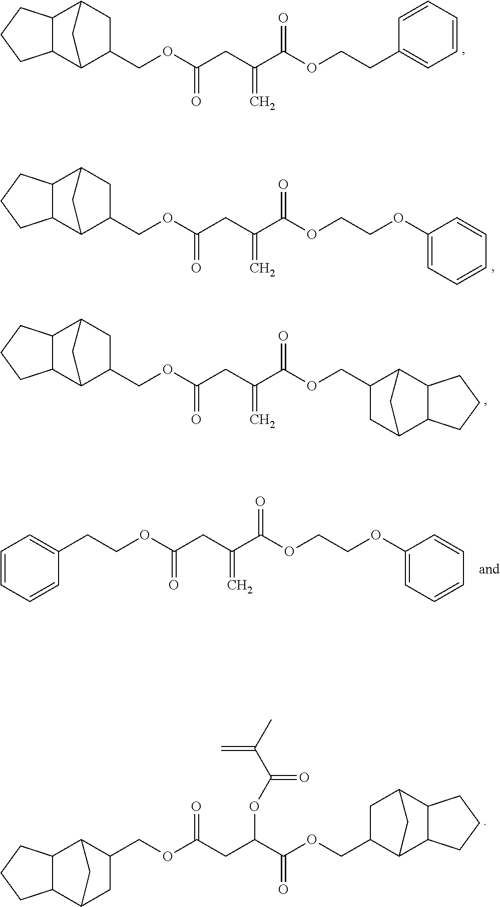 [SMILES: C=C(CC(=O)OCC1CC2CC1C1CCCC21)C(=O)OCCc1ccccc1 ; C=C(CC(=O)OCC1CC2CC1C1CCCC21)C(=O)OCCOc1ccccc1 ; C=C(CC(=O)OCC1CC2CC1C1CCCC21)C(=O)OCC1CC2CC1C1CCCC21 ; C=C(CC(=O)OCCc1ccccc1)C(=O)OCCOc1ccccc1 ; C=C(C)C(=O)OC(CC(=O)OCC1CC2CC1C1CCCC21)C(=O)OCC1CC2CC1C1CCCC21]
